(19) United States
(12) Patent Application Publication
(10) Pub. No.: US 2023/0302858 A1
(43) Pub. Date: Sep. 28, 2023

(54) A RECOVERY LINE CONNECTION APERTURE INTERFACE MEMBER FOR A VEHICLE RECOVERY POINT

(71) Applicant: MercuryPM Pty Ltd, Kilsyth (AU)

(72) Inventor: Stephen Handbury, Kilsyth (AU)

(21) Appl. No.: 18/005,654

(22) PCT Filed: Jul. 20, 2021
(86) PCT No.: PCT/AU2021/050778

§ 371 Date: Jan. 16, 2023

(30) Foreign Application Priority Data
Aug. 5, 2020 (AU) 2020902736

(51) Int. Cl. B60D 1/18; B60D 1/48

(52) U.S. Cl. CPC B60D 1/187; B60D 1/488

(57) ABSTRACT

A recovery line connection aperture interface member for a vehicle recovery point increases load rating capacity of rope product inserted through the recovery point. The recovery point has a plate having the recovery line connection aperture through a distal end thereof. The interface member is applied against a side surface of the plate to interface an edge of the aperture so that an outer bearing surface of the interface member increases a bend radius of the recovery line connection around the edge of the connection aperture in use.

### FIELD OF THE INVENTION

This invention relates generally to a recovery line connection aperture interface member for a vehicle recovery point which increase the effective D/d ratio thereof and therefore load rating capacity of a soft shackle or similar rope product inserted through the aperture.

### BACKGROUND OF THE INVENTION

A vehicle recovery point provides a secure and functional attachment point for performing vehicle recoveries using snatch straps, kinetic rope, soft shackles and similar accessories.

Recovery points have been tested and rated to handle extreme strain during vehicle recovery, including by load testing and/or finite element analysis.

Soft shackles may be used to attach to vehicle recovery points. A soft shackle comprises a strop of rope with a stopper at one end (typically a knot) and spliced at the other end. The stopper is inserted through the spliced end to close the soft shackle. A soft shackle typically comprises high modulus polyethylene rope, such as Dyneema™, Spectra™, SaberPRO™ or the like.

A soft shackle is typically of 8 or 12 strand instruction and may typically vary in diameter from 6 to 48 mm. Most soft shackles used for 4×4 recovery are 10 to 12 mm thick and constructed from 12-strand UMHWPE, typically having a maximum breaking strain rating in excess of 9,000 kg.

The present invention seeks to provide a vehicle recovery point, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a recovery line connection aperture interface member for a vehicle recovery point. The vehicle recovery point is attached to a chassis of a vehicle and comprises a plate having a recovery line connection aperture through a distal end thereof. In use, a recovery line connector, such as a soft shackle or the like is connected through the connection aperture for towing and/or recovery operation.

The interface member is applied against the side surface of the plate to interface and edge of the aperture so that an outer bearing surface of the interface member increases the bend radius of the recovery line connection around the edge of the connection aperture in use.

In other words, the outer bearing surfaces increase the effective D/d ratio and therefore load rating capacity of the rope product inserted through the aperture.

In a preferred embodiment, interface members are applied either side of the plate to increase the bend radius at respective edges of the connection aperture.

The interface member may comprise a planar inner surface lying flat against the side surface of the plate. The interface member may be metallic and welded to the side of the plate.

The outer bearing surface may be curved on an inside thereof, preferably being semicircular in cross-section to bend the connector therearound through 90° through the connection aperture.

An inner edge of the interface member may meet the edge of the connection aperture to smoothly transition the connector into the connection aperture to avoid abrading the connector. The inner edge may be rounded to a radius of approximately 0.5 mm and/or the connection aperture may be slightly chamfered to avoid sharp edges at the transition therebetween.

The interface member is preferably annular so that the interface member can interface the connector irrespective of the angle of the connector to the recovery point in the vertical plane.

Furthermore, the outer bearing surface may be curved on an outside thereof to increase the bend radius of the connection even if the connection is not connected straight to the recovery point in the horizontal plane.

Furthermore, a portion of an outer edge of the interface member may meet an outer edge of the plate to avoid sharp edges.

In accordance with a further form of the interface member, the interface member comprises an insertion portion which inserts within the connection aperture. The insertion portion may define an outer fitting surface which fits against an inner surface of the connection aperture and an inner surface continuing from the outer bearing surface. The inner surface continuing from the outer bearing surface avoids sharp edges therebetween.

The insertion portion may be cylindrical and may comprise a peripheral stress relief notch to fit within the connection aperture which is typically laser cut (as opposed to more smoothly drilled out).

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a perspective view of recovery line connection aperture interface members applied to a vehicle recovery point;

FIG. 2 shows an exploded perspective view of the recovery point of FIG. 1;

FIG. 3 shows a cross-sectional view of a distal end of the recovery point;

FIG. 4 shows a side elevation view of the interface member in accordance with an embodiment;

FIG. 5 shows a side cross-sectional view of the recovery member of FIG. 4;

FIG. 6 shows a magnified view of an inner edge of the recovery point of FIG. 4;

FIG. 7 shows a side view of interface members in accordance with a further embodiment applied to a recovery point;

FIG. 8 shows a side view of the interface member of FIG. 7;

FIG. 9 shows a cross-sectional view of the interface member of FIG. 7;

FIG. 10 shows a side view of the interface member of FIG. 7 with exemplary dimensions;

FIG. 11 shows a magnified side view of the interface member of FIG. 7 with a stress relief notch; and

FIG. 12 shows a rear side view of the interface member of FIG. 7.

### DESCRIPTION OF EMBODIMENTS

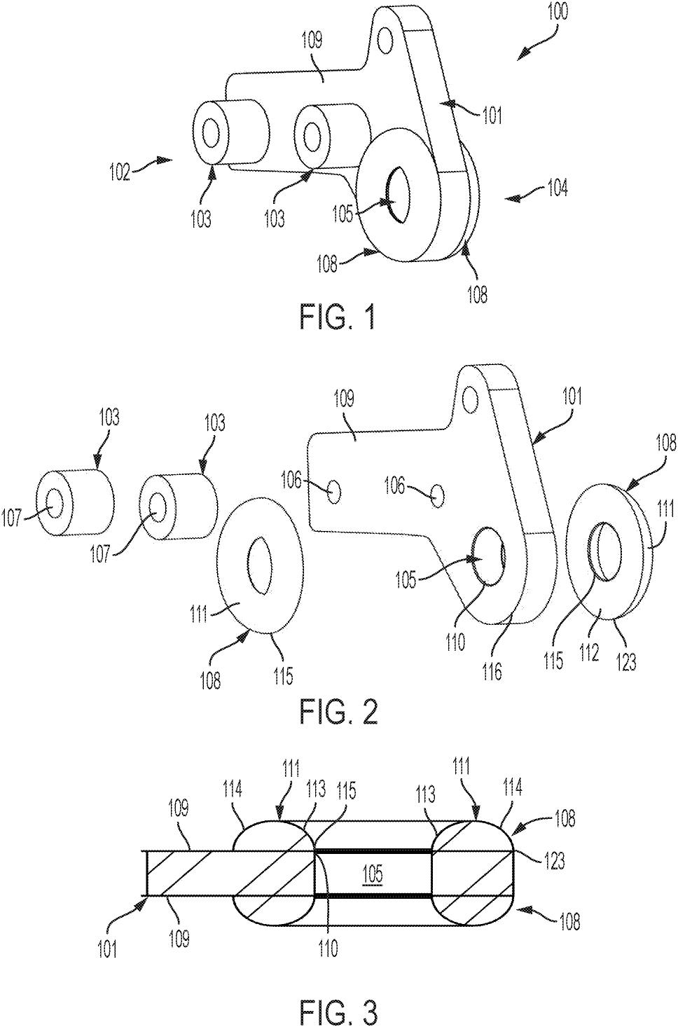

FIG. 1 shows a vehicle recovery point 100 comprising a load rated metal plate 101 having a proximal end 102 which may be fastened to a vehicle chassis by chassis connection lugs 103 and a distal end 104 comprising recovery line connection aperture 105 therethrough. In use, a recovery line may be connected to the aperture 105 using the recovery line connection, such as a soft shackle or similar rope product.

FIG. 1 shows a right-hand form of the recovery point 100 and a left-hand form is typically installed adjacently on the vehicle chassis. The recovery point 100 of FIG. 1 is suited for a Toyota™ Landcruiser™ vehicle. However, the recovery point 100 may have different shapes and configurations for other types of vehicles.

With reference to the exploded representation of FIG. 2, the plate 101 may comprise fasting apertures 106 therethrough which collocate with bores 107 of respective chassis connection lugs 103. The chassis connection lugs 103 may typically be installed on one side of the plate 101 either for the left-hand or right-hand form of the recovery point 100. The lugs 103 may be attached to the plate 101 by peripheral bead welding.

A recovery line connection aperture interface member 108 is applied against a side surface 109 of the plate 101 to interface an edge 110 of the aperture 105 so that an outer bearing surface 111 of the interface member 108 increases a bend radius of the recovery line connection around the edge 110 of the connection aperture 105 in use.

In accordance with the preferred embodiment shown, a pair of interface members 108 are applied to opposite sides of the plate 101 so that each increases the bend radius of the recovery line connection around respective edges 110 of the connection aperture 105 in use.

The interface member 108 may comprise a planar inner surface 112 lying against the side surface 109 of the plate 101 adjacent the aperture 105.

The interface member 108 may be metallic and may be welded to the side surface 109.

With reference to FIG. 3 the outer bearing surface 111 may be curved on an inside 113 thereof. The outer bearing surface 111 may be semicircular in cross-section on the inside 113.

Furthermore, the outer bearing surface 111 may be curved on an outside 114 thereof. The curvature on the outside 114 may be similarly semicircular in cross-section.

The entire bearing surface 111 may be semicircular in cross-section and may arc through 180°.

As shown in FIG. 3, an inner edge 115 of the interface member 108 may be substantially orthogonal with respect to the side surface 109.

Furthermore, the inner edge 115 of the interface member 108 may meet the edge 110 of the connection aperture 105. FIG. 6 shows wherein the inner edge 115 is rounded to a radius of approximately 0.5 mm to avoid sharp edges which could abrade the connector. Similarly, the edge 110 of the connection aperture 105 may be slightly chamfered.

An outer edge 123 of the interface member 108 may be substantially orthogonal with respect to the side surface 109. A portion of the outer edge 123 may meet an outer edge 116 of the plate 101. Furthermore, the portion of the outer edge 123 may follow the outer edge 116 of the plate 101.

In the preferred embodiment shown, the interface member 108 is annular.

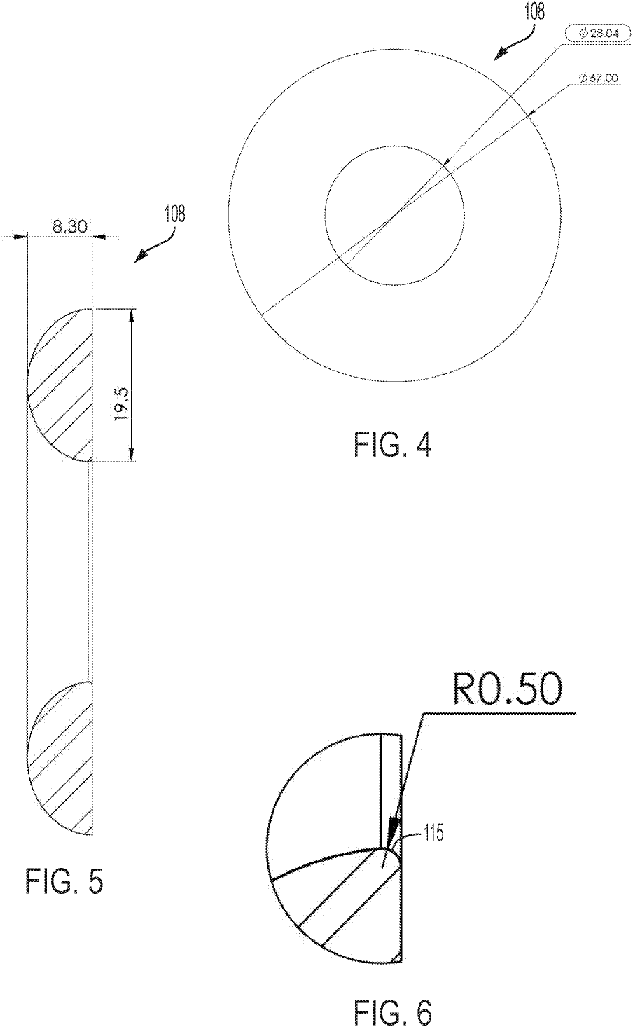

FIGS. 4 and 5 show exemplary dimensions wherein, with reference to FIG. 4 interface member 108 may comprise an outer diameter of approximately 67 mm and an inner diameter of approximately 28 mm.

Furthermore, with reference to FIG. 5, the interface member 108 may be approximately 19.5 millimetres wide and 8.3 millimetres deep.

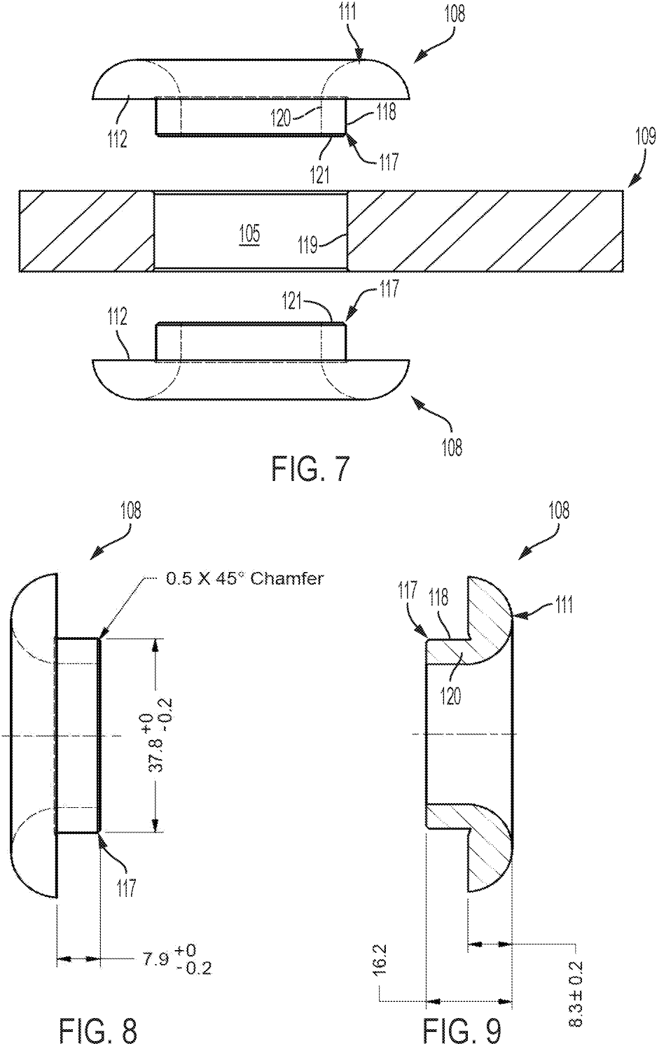

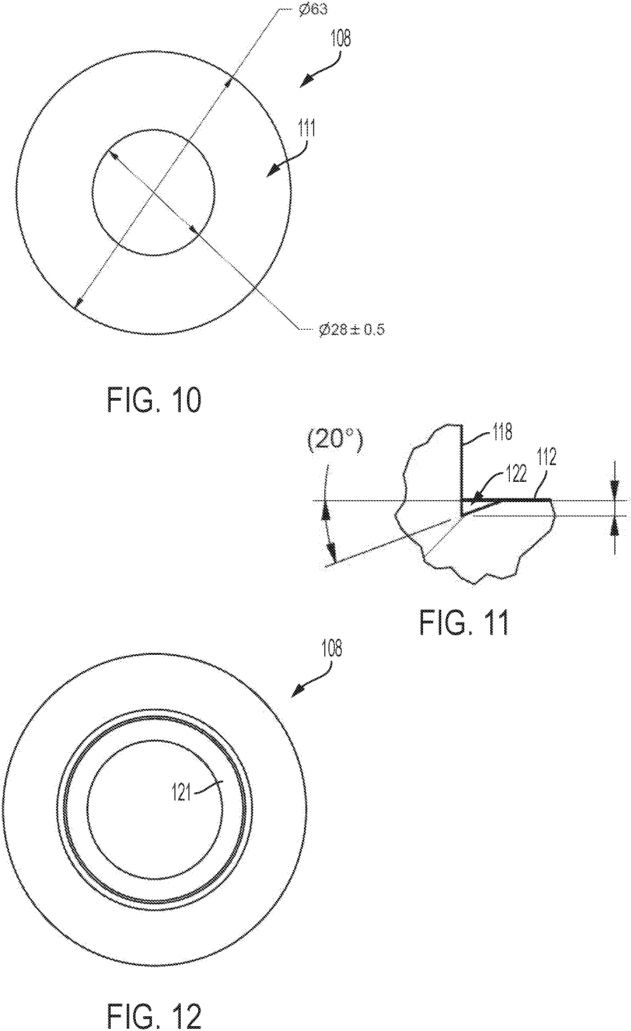

FIG. 7 shows the interface member 108 in accordance with a further embodiment wherein the interface member 108 defines an insertion portion 117 which fits within the connection aperture 105. The insertion portion 117 may define an outer fitting surface 118 which fits against an inner surface 119 of the connection aperture 105. Furthermore, the insertion portion 117 may define an inner surface 120 continuing from the outer bearing surface 111.

The insertion portion 117 may be cylindrical.

The insertion portion 117 may insert halfway into the connection aperture 105 or less. As shown in FIG. 7, a pair of the interface members 108 may be inserted in either end of the aperture 105 so that the insertion portions 117 meet within the connection aperture 105. The insertion portion 117 may define a planar distal face 121 adjacent and orthogonal with respect to the outer fitting surface 118 and wherein the distal faces 121 of the interface members 108 meet end on within the aperture 105. Once assembled in this way, the inner surfaces 120 may be sanded to reduce any edges between the distal faces 121.

The insertion portion 117 may comprise a slight chamfer between the outer fitting surface 118 and the distal face 121.

The interface member 108 may define the planar inner surface 112 adjacent an orthogonal to the outer fitting surface 118 of the insertion portion 117.

With reference to FIG. 11, the interface member 108 may comprise a stress relief notch 122 recessed within the planar inner surface 118 adjacent the outer fitting surface 118.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A recovery line connection aperture interface member for a vehicle recovery point, the recovery point comprising a plate having the recovery line connection aperture through a distal end thereof, wherein the interface member is applied against a side surface of the plate to interface an edge of the aperture so that an outer bearing surface of the interface member increases a bend radius of the recovery line connection around the edge of the connection aperture in use.

2. The interface member as claimed in claim 1, wherein a pair of interface members are applied to opposite sides of the plate so that each increases the bend radius of the recovery line connection around respective edges of the connection aperture in use.

3. The interface member as claimed in claim 1, wherein the interface member comprises a planar inner surface lying against the side surface of the plate adjacent the aperture.

4. The interface member as claimed in claim 3, wherein the interface member is welded to the side surface.

5. The interface member as claimed in claim 1, wherein the outer bearing surface is curved on an inside thereof.

6. The interface member as claimed in claim 1, wherein the outer bearing surface is curved on an outside thereof.

7. The interface member as claimed in claim 1, wherein the outer bearing surface is semicircular in cross-section.

8. The interface member as claimed in claim 7, wherein the outer bearing surface arcs through 180°.

9. The interface member as claimed in claim 1, wherein the outer bearing surface is substantially orthogonal with respect to the side surface of the plate at an inner edge of the interface member.

10. The interface member as claimed in claim 1, wherein an inner edge of the interface member meets the edge of the connection aperture.

11. The interface member as claimed in claim 1, wherein the outer bearing surface is substantially orthogonal with respect to the side surface of the plate at an outer edge of the interface member.

12. The interface member as claimed in claim 1, wherein an outer edge of the outer bearing surface meets an outer edge of the plate.

13. The interface member as claimed in claim 12, wherein a portion of the outer edge of the interface member follows the outer edge of the plate.

14. The interface member as claimed in claim 1, wherein an inner edge of the interface member is rounded.

15. The interface member as claimed in claim 14, wherein the inner edge has a radius of approximately 0.5 mm.

16. The interface member as claimed in claim 1, further comprising the recovery point and wherein the edge of the connection aperture is chamfered.

17. The interface member as claimed in claim 1, wherein the interface member is annular.

18. The interface member as claimed in claim 1, wherein the interface member defines an insertion portion which fits within the connection aperture, the insertion portion defining an outer fitting surface which fits against an inner surface of the connection aperture and an inner surface continuing from the outer bearing surface.

19. The interface member as claimed in claim 18, wherein the insertion portion is cylindrical.

20. The interface member as claimed in claim 18, wherein the insertion portion inserts half way into the connection aperture or less.

21. The interface member as claimed in claim 20, wherein a pair of interface members are applied to opposite sides of the plate and wherein respective insertion portions thereof meet within the connection aperture.

22. The interface member as claimed in claim 21, wherein the insertion portion defines a planar distal face and wherein distal faces of the insertion portions meet end on.

23. The interface member as claimed in claim 18, wherein the insertion portion defines a planar inner surface adjacent and orthogonal to the outer fitting surface of the insertion portion.

25. The interface member as claimed in claim 23, further comprising a stress relief notch in the planar inner surface adjacent the outer fitting surface.

26. A method of interfacing a recovery line connection aperture of a recovery point, the method comprising applying the interface member as claimed in claim 1 to a side of a plate of the recovery point so that an outer bearing surface of the interface member increases a bend radius of the recovery line connection around the edge of the connection aperture in use.

27. The method as claimed in claim 26, wherein the method comprises applying a pair of interface members to opposite sides of a plate of the recovery point so that each increases the bend radius of the recovery line connection around respective edges of the connection aperture in use.
